(19) United States
(12) Patent Application Publication
(10) Pub. No.: US 2025/0300407 A1
(43) Pub. Date: Sep. 25, 2025

(54) Shielding Component and Connector

(71) Applicants: Tyco Electronics Technology (SIP) Co., Ltd., Suzhou (CN); Tyco Electronics (Shanghai) Co., Ltd., Shanghai (CN)

(72) Inventors: Neil Shi, Shanghai (CN); Jianxiong (Jesse) Li, Shanghai (CN); Reicky Zhang, Shanghai (CN); Lei Li, Suzhou (CN); Tomo Hu, Suzhou (CN)

(73) Assignees: Tyco Electronics Technology (SIP) Co., Ltd., Suzhou (CN); Tyco Electronics (Shanghai) Co., Ltd., Shanghai (CN)

(21) Appl. No.: 19/083,665

(22) Filed: Mar. 19, 2025

(30) Foreign Application Priority Data
Mar. 19, 2024 (CN) 202410316169.1

(51) Int. Cl. H01R 13/6592

(52) U.S. Cl. CPC H01R 13/6592

(57) ABSTRACT

A shielding component insertable into a socket of a connector housing includes a cylindrical body having a peripheral wall enclosing an inner cavity. The peripheral wall has a first side edge portion and a second side edge portion extending along an axial direction of the cylindrical body. The first side edge portion is stacked on an outer side of the second side edge portion and connected to the second side edge portion. The first side edge portion protrudes from an outer peripheral surface of the cylindrical body and is matable with a guide groove formed on an inner peripheral surface of the socket of the connector housing to ensure that the shielding component is inserted into the socket in a correct orientation.

### CROSS-REFERENCE TO RELATED APPLICATION

This application claims the benefit of the filing date under 35 U.S.C. § 119(a)-(d) of Chinese Patent Application No. 202410316169.1, filed on Mar. 19, 2024.

### FIELD OF THE INVENTION

The present invention relates to a shielding component and a connector comprising the shielding component.

### BACKGROUND OF THE INVENTION

A connector typically includes a housing, a terminal holder, a terminal, and a shielding component. A socket is formed in the housing, and the shielding component is cylindrical and inserted into the socket. The terminal is inserted into the terminal holder, and the terminal holder is inserted into the shielding component.

In order to ensure that the shielding component is inserted into the socket of the housing in the correct orientation, an orientation structure must be formed on the shielding component and the housing. Usually, the orientation structure includes a guide rib formed on the shielding component and a guide groove formed inside the housing. The guide rib is mated with the guide groove to ensure that the shielding component is inserted into the socket of the housing in the correct orientation. However, forming the guide rib on the shielding component increases manufacturing difficulty and manufacturing costs.

### SUMMARY OF THE INVENTION

A shielding component insertable into a socket of a connector housing includes a cylindrical body having a peripheral wall enclosing an inner cavity. The peripheral wall has a first side edge portion and a second side edge portion extending along an axial direction of the cylindrical body. The first side edge portion is stacked on an outer side of the second side edge portion and connected to the second side edge portion. The first side edge portion protrudes from an outer peripheral surface of the cylindrical body and is matable with a guide groove formed on an inner peripheral surface of the socket of the connector housing to ensure that the shielding component is inserted into the socket in a correct orientation.

### BRIEF DESCRIPTION OF THE DRAWINGS

The invention will now be described by way of example with reference to the accompanying figures, of which:

FIG. 1 shows an illustrative perspective view of a connector according to an exemplary embodiment of the present invention;

FIG. 2 shows an axial sectional view of a connector according to an exemplary embodiment of the present invention;

FIG. 3 shows an axial sectional view of a cable assembly of a connector according to an exemplary embodiment of the present invention;

FIG. 4 shows an illustrative perspective view of a housing and a shielding component of a connector according to an exemplary embodiment of the present invention;

FIG. 5 shows an illustrative perspective view of a shielding component of a connector according to an exemplary embodiment of the present invention;

FIG. 6 shows a cross-sectional perspective view of a shielding component of a connector according to an exemplary embodiment of the present invention;

FIG. 7 shows a cross-sectional exploded perspective view of the housing and shielding component of a connector according to an exemplary embodiment of the present invention;

FIG. 8 shows a cross-sectional perspective view of the housing and shielding component of a connector according to an exemplary embodiment of the present invention;

FIG. 9 shows a cross-sectional perspective view of the shielding component and terminal holder of a connector according to an exemplary embodiment of the present invention; and

FIG. 10 shows a cross-sectional exploded perspective view of the shielding component and terminal holder of a connector according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

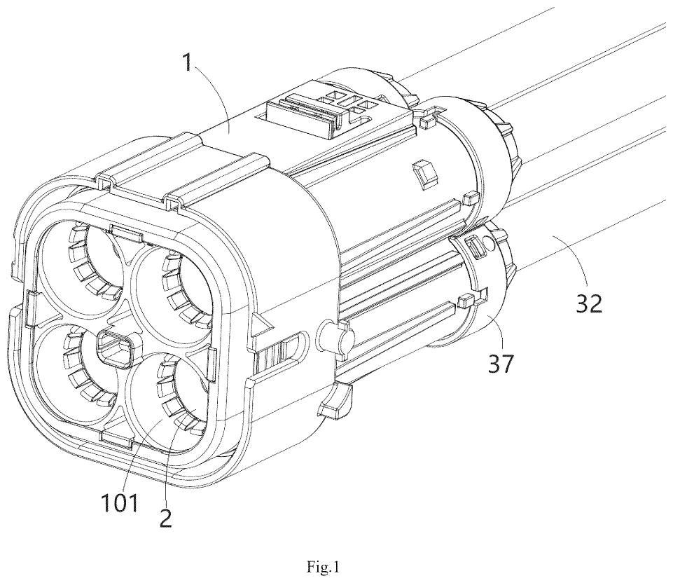

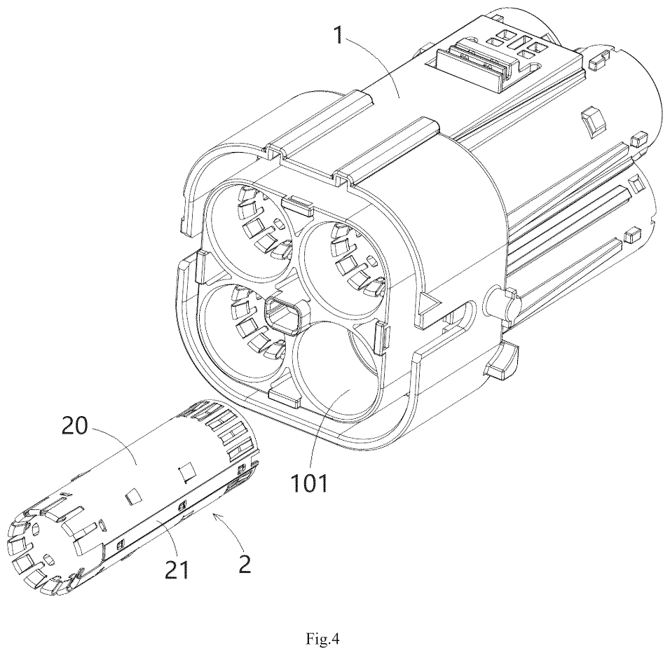

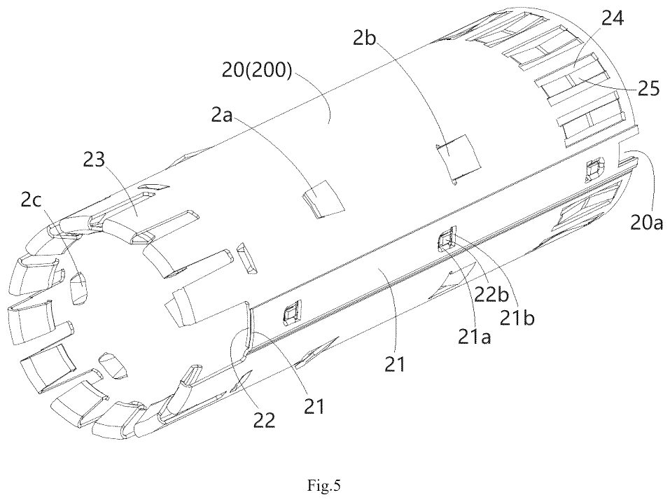

As shown in FIGS. 1 to 7, in an exemplary embodiment of the present invention, a shielding component 2 is disclosed. The shielding component 2 is suitable for insertion into a socket 101 of a housing 1 of a connector. The shielding component 2, as shown in FIG. 5, has a cylindrical body 20, which includes a peripheral wall 200 for enclosing an inner cavity. The peripheral wall 200 has a first side edge portion 21 and a second side edge portion 22 extending along the axial direction of the cylindrical body 20. The first side edge portion 21 is stacked on an outer side of the second side edge portion 22 and connected to the second side edge portion 22. In an embodiment, the first side edge portion 21 and the second side edge portion 22 are riveted together.

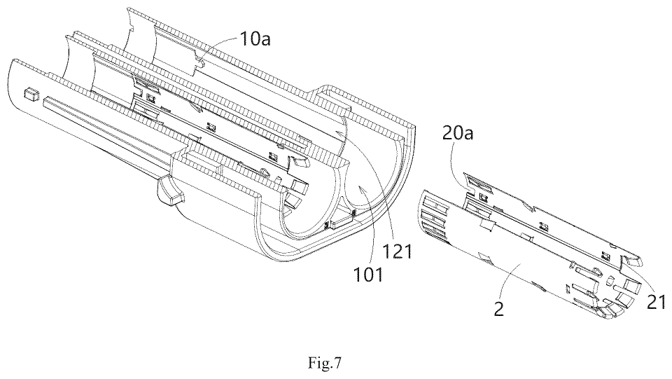

As shown in FIG. 7, in the illustrated embodiment, the first side edge portion 21 protrudes from the outer peripheral surface of the cylindrical body 20 and is used to mate with a guide groove 121 formed on the inner peripheral surface of the socket 101 of the connector housing 1 to ensure that the shielding component 2 is inserted into the socket 101 in the correct orientation.

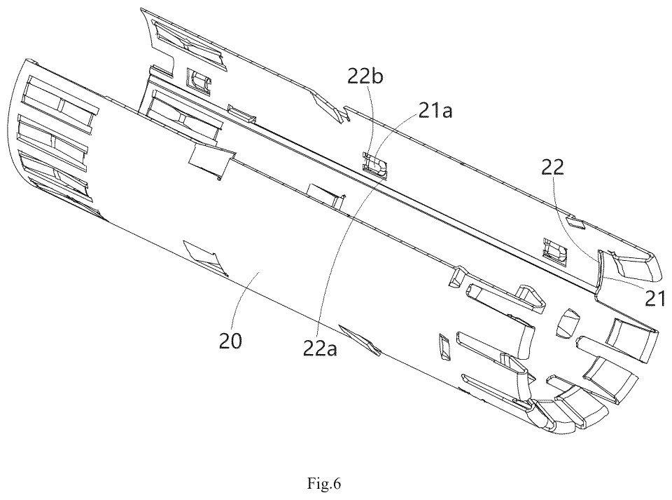

As shown in FIG. 6, in the illustrated embodiment, a plurality of openings 22a are formed in the second side edge portion 22. The openings 22a are spaced apart in the axial direction of the cylindrical body 20. Multiple joint portions 21a corresponding to the multiple openings 22a are formed on the first side edge portion 21. The joint portion 21a is formed by stamping, with its outer side concave inward relative to the outer circumferential surface of the cylindrical body 20, and its inner side protruding inward relative to the inner circumferential surface of the cylindrical body 20. The inner sides of the multiple joint portions 21a respectively protrude into the multiple openings 22a and are respectively joined to the multiple openings 22a.

As shown in FIGS. 5 and 6, in the illustrated embodiment, multiple tongue portions 22b are formed on the second side edge portion 22, which are respectively located in the multiple openings 22a and connected to the side edges of multiple openings 22a. The outer side of the joint portion 21a is concave inward and a slot hole 21b is formed in the joint portion 21a to allow the tongue portion 22b to pass through. The tongue portion 22b passes through the slot hole 21b and is bent onto the outer side of the joint portion 21a.

In another embodiment, the first side edge portion 21 and the second side edge portion 22 are welded together. For example, the first side edge portion 21 and the second side edge portion 22 can be welded together by ultrasonic welding.

As shown in FIG. 5, in the illustrated embodiment, the cylindrical body 20 has a front end and a rear end that are opposite in its axial direction, and a notch 20a is formed in the rear ends of the first side edge portion 21 and the second side edge portion 22. The notch 20a is used to engage with a protruding tongue 10a formed in the guide groove 121 of the connector housing 1, shown in FIG. 7, to position the shielding component 2 in the circumferential direction of the cylindrical body 20.

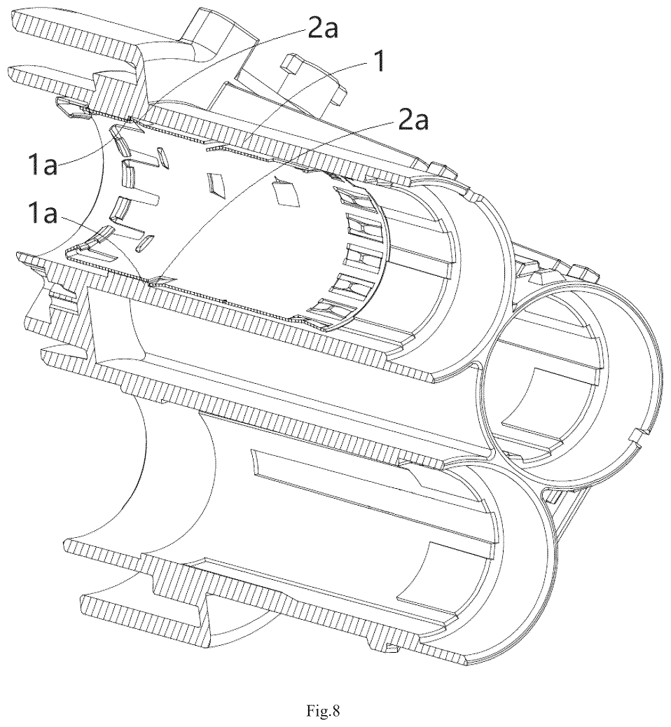

As shown in FIG. 5, in the illustrated embodiment, multiple first locking springs 2a are formed on the peripheral wall 200 of the cylindrical body 20, and the multiple first locking springs 2a are distributed at intervals in the circumferential direction of the cylindrical body 20. The first locking spring 2a is located on the outer side of the cylindrical body 20 and extends obliquely towards the front end of the cylindrical body 20. As shown in FIG. 8, the first locking spring 2a is used to rest against the first step portion 1a inside the socket 101 of the connector housing 1, to lock the shielding component 2 in the socket 101 of the connector housing 1.

As shown in FIG. 5, in the illustrated embodiment, the shielding component 2 further includes multiple contact springs 23, which are connected to the front end of the cylindrical body 20 and distributed at intervals in the circumferential direction of the cylindrical body 20. The end of the contact spring 23 is bent inward into a hook shape for electrical contact with an outer peripheral surface of a mating shield of a mating connector inserted into the front end of the shielding component 2.

As shown in FIG. 5, in the illustrated embodiment, multiple windows 24 and multiple contact spring arms 25 are formed on the rear end of the cylindrical body 20, and the multiple windows 24 are distributed at intervals in the circumferential direction of the cylindrical body 20. The front and rear ends of the contact spring arm 25 are respectively connected to the front and rear side edges of the window 24, and the contact spring arm 25 is arched inward for electrical contact with an outer peripheral surface of a shielding connection component 33 inserted into the rear end of the shielding component 2.

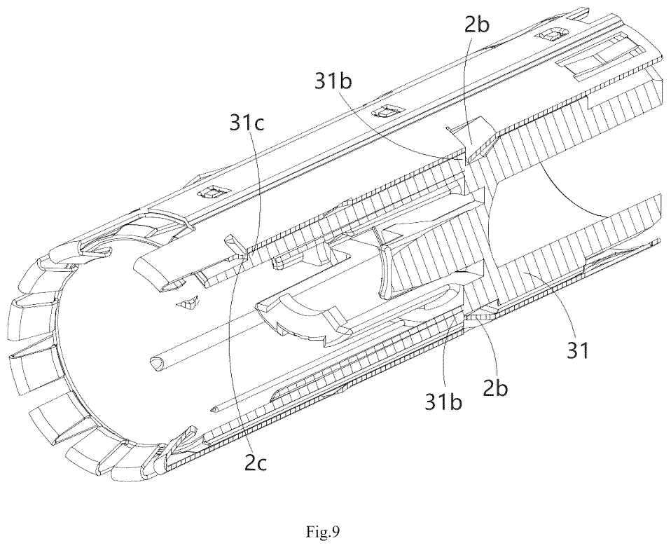

As shown in FIG. 5, in the illustrated embodiment, multiple second locking springs 2b are formed on the peripheral wall 200 of the cylindrical body 20. Multiple second locking springs 2b are distributed at intervals in the circumferential direction of the cylindrical body 20. The second locking spring 2b is located on the inner side of the cylindrical body 20 and extends obliquely towards the front end of the cylindrical body 20, used to rest against a second step portion 31b on a terminal holder 31 inserted into the shielding component 2, as shown in FIG. 9, to prevent the inserted terminal holder 31 from being pulled out of the shielding component 2.

As shown in FIG. 5, in the illustrated embodiment, multiple positioning protrusions 2c are formed on the peripheral wall 200 of the cylindrical body 20, which are distributed at intervals in the circumferential direction of the cylindrical body 20 and protrude towards the interior of the cylindrical body 20. The positioning protrusion 2c is used to rest on the third step 31c of the terminal holder 31 inserted into the shielding component 2, as shown in FIG. 9, to axially position the inserted terminal holder 31.

In an embodiment, the shielding component 2 is an integral stamped part, which can improve manufacturing efficiency and reduce manufacturing costs.

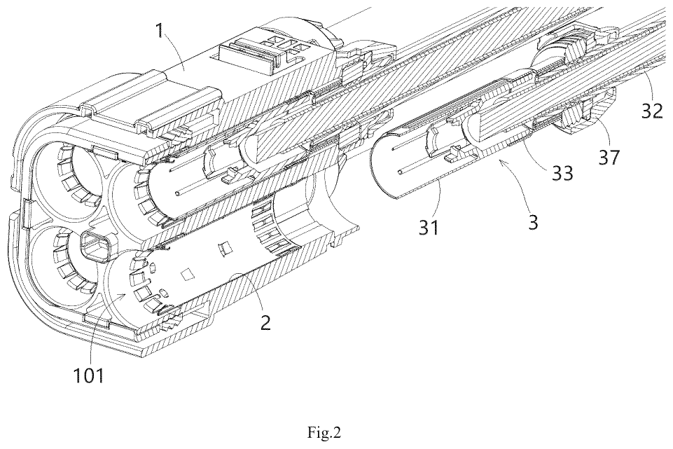

As shown in FIGS. 1 and 2, in another exemplary embodiment of the present invention, a connector is also disclosed. The connector includes a housing 1 and a shielding component 2. A socket 101 is formed in the housing 1. The shielding component 2 is inserted into the socket 101 of the housing 1. A guide groove 121 extending along the axial direction of the socket 101 is formed on the inner peripheral surface of the socket 101 of the housing 1. The guide groove 121 is mated with the first side edge portion 21 protruding outward on the shielding component 2 to ensure that the shielding component 2 is inserted into the socket 101 in the correct orientation, as shown in FIG. 7.

As shown in FIG. 8, in the illustrated embodiment, a first step portion 1a is formed on the inner peripheral surface of the socket 101, and the first locking spring 2a of the shielding component 2 is axially pressed against the first step portion 1a to prevent the shielding component 2 from being pulled out of the socket 101 of the housing 1.

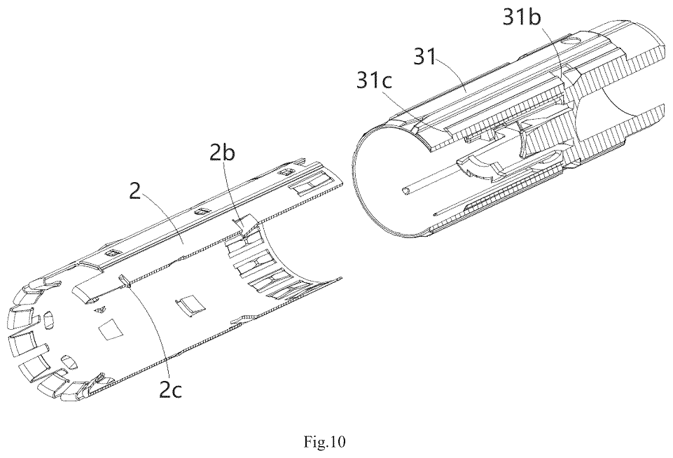

As shown in FIGS. 1 to 10, in the illustrated embodiment, the socket 101 has front and rear ports that are opposite in its axial direction, and the shielding component 2 is inserted into the socket 101 through the front port. The connector also includes a terminal holder 31, which is cylindrical and inserted into the cylindrical body 20 of the shielding component 2 through the rear port of the socket 101. A second step portion 31b is formed on the terminal holder 31, and the second locking spring 2b of the shielding component 2 is axially pressed against the second step portion 31b to prevent the terminal holder 31 from being pulled out of the shielding component 2.

As shown in FIG. 9, in the illustrated embodiment, a third step portion 31c is formed on the terminal holder 31, and the positioning protrusion 2c of the shielding component 2 is axially pressed against the third step portion 31c to axially position the inserted terminal holder 31.

As shown in FIGS. 1 to 3, in the illustrated embodiment, the connector further includes a terminal and a cable 32. The terminal is inserted into the terminal holder 31 for mating with a mating terminal of a mating connector inserted into the socket 101. One end of the cable 32 extends into the terminal holder 31 through the rear port of socket 101 and is electrically connected to the terminal.

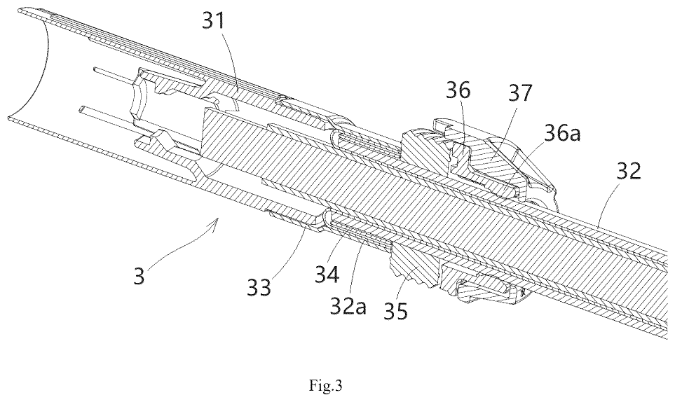

As shown in FIGS. 2 and 3, in the illustrated embodiment, the connector further includes a shielding connection component 33. The shielding connection component 33 is cylindrical in shape, with its front end fitted onto the rear end of the terminal holder 31, and its rear end pressed onto the exposed shielding layer 32a of the cable 32. The front end of the shielding connection component 33 is inserted into the rear end of the shielding component 2 and electrically contacts with the contact spring arm 25 of the shielding component 2 to achieve electrical connection between the shielding component 2 and the shielding layer 32a of the cable 32.

As shown in FIG. 3, in the illustrated embodiment, the connector further includes a support sleeve 34, which is fitted onto the cable 32 to support the rear end of the shielding connection component 33. The exposed shielding layer 32 of cable 32 is folded back onto the outer side of support sleeve 34 and clamped between the rear end of shielding connection component 33 and support sleeve 34.

As shown in FIG. 3, in the illustrated embodiment, the connector further includes a sealing ring 35, which is fitted onto the cable 32 and inserted into the rear port of the socket 101 for sealing the rear port of the socket 101.

As shown in FIG. 3, in the illustrated embodiment, the connector further comprises a rear cover 37 and a cable clamp 36. The rear cover 37 is fitted onto the cable 32 and fastened to the rear end of the housing 1. The cable clamp 36 is fitted onto the cable 32 and accommodated in the rear cover 37. The cable clamp 36 has multiple elastic claws 36a surrounding the cable 32, which clamp the cable 32 under the radial compression of the rear cover 37 to fix the cable 32 to the housing 1.

As shown in FIGS. 2 and 3, in the illustrated embodiment, the terminal holder 31, the terminal, the cable 32, the shielding connection component 33, the support sleeve 34, the sealing ring 35, the cable clamp 36, and the rear cover 37 are pre-assembled into a cable assembly 3 and inserted together into the socket 101 of the housing 1.

As shown in FIGS. 1, 2, and 4, in the illustrated embodiment, the housing 1 has multiple sockets 101, and the connector has multiple shielding components 2, which are respectively inserted into the multiple sockets 101 from the front end of the housing 1. The connector has multiple cable assemblies 3, which are respectively inserted into multiple sockets 101 from the rear end of the housing 1.

In the aforementioned exemplary embodiments according to the present invention, the overlapping side edge portions of the shielding component are used as an orientation structure for mating with the guide groove inside the housing. Therefore, there is no need to separately form an orientation structure on the shielding component, which simplifies the manufacturing of the shielding component and reduces production costs.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A shielding component insertable into a socket of a connector housing, comprising:
a cylindrical body having a peripheral wall enclosing an inner cavity, the peripheral wall has a first side edge portion and a second side edge portion extending along an axial direction of the cylindrical body, the first side edge portion is stacked on an outer side of the second side edge portion and connected to the second side edge portion, the first side edge portion protrudes from an outer peripheral surface of the cylindrical body and is matable with a guide groove formed on an inner peripheral surface of the socket of the connector housing to ensure that the shielding component is inserted into the socket in a correct orientation.

2. The shielding component of claim 1, wherein the first side edge portion and the second side edge portion are riveted together.

3. The shielding component of claim 2, wherein a plurality of openings are formed in the second side edge portion and are spaced apart in the axial direction of the cylindrical body, a plurality of joint portions corresponding to the openings are formed on the first side edge portion, the joint portions respectively protrude into the openings and are respectively joined to the openings.

4. The shielding component of claim 3, wherein a plurality of tongue portions are formed on the second side edge portion, the tongue portions are respectively located in the openings and connected to a plurality of side edges of the openings, an outer side of each of the joint portions is concave inward and a slot hole is formed in the joint portion to allow one of the tongue portions to pass through, the tongue portion passes through the slot hole and is bent onto the outer side of the joint portion.

5. The shielding component of claim 1, wherein the first side edge portion and the second side edge portion are welded together.

6. The shielding component of claim 1, wherein the cylindrical body has a front end and a rear end that are opposite in the axial direction, a notch is formed in the rear end of the first side edge portion and the second side edge portion, the notch engages a protruding tongue formed in the guide groove of the connector housing to position the shielding component in a circumferential direction of the cylindrical body.

7. The shielding component of claim 1, wherein a plurality of first locking springs are formed on the peripheral wall of the cylindrical body, the first locking springs are distributed at intervals in a circumferential direction of the cylindrical body, the first locking springs are each located on an outer side of the cylindrical body and extend obliquely towards a front end of the cylindrical body, the first locking springs rest on a first step portion inside the socket of the connector housing to lock the shielding component in the socket.

8. The shielding component of claim 1, further comprising a plurality of contact springs connected to a front end of the cylindrical body and distributed at intervals in a circumferential direction of the cylindrical body, each of the contact springs has an end bent inward into a hook shape and electrically contacting an outer peripheral surface of a mating shielding component of a mating connector inserted into the front end of the cylindrical body.

9. The shielding component of claim 1, wherein a plurality of windows and a plurality of contact spring arms located respectively in the windows are formed on a rear end of the cylindrical body, the windows are distributed at intervals in a circumferential direction of the cylindrical body, a front end and a rear end of each of the contact spring arms are respectively connected to a front side edge and a rear side edge of one of the windows, and the contact spring arms are arched inward for electrical contact with an outer peripheral surface of a shielding connection component inserted into the rear end of the cylindrical body.

10. The shielding component of claim 1, wherein a plurality of second locking springs are formed on the peripheral wall of the cylindrical body, the second locking springs are distributed at intervals in a circumferential direction of the cylindrical body, the second locking springs are located on an inner side of the cylindrical body and extend obliquely towards a front end of the cylindrical body, the second locking springs rest against a second step portion of a terminal holder inserted into the shielding component to prevent the terminal holder from being pulled out of the shielding component.

11. The shielding component of claim 1, wherein a plurality of positioning protrusions are formed on the peripheral wall of the cylindrical body, the positioning protrusions are distributed at intervals in a circumferential direction of the cylindrical body and protrude towards an interior of the cylindrical body, the positioning protrusions rest against a third step portion on a terminal holder inserted into the shielding component to axially position the terminal holder.

12. The shielding component of claim 1, wherein the shielding component is an integral stamped part.

13. A connector, comprising:
a housing having a socket, a guide groove extending along an axial direction of the socket is formed on an inner peripheral surface of the socket; and
a shielding component inserted into the socket, the shielding component including a cylindrical body having a peripheral wall enclosing an inner cavity, the peripheral wall has a first side edge portion and a second side edge portion extending along the axial direction, the first side edge portion is stacked on an outer side of the second side edge portion and connected to the second side edge portion, the first side edge portion protrudes from an outer peripheral surface of the cylindrical body and is mated with the guide groove to ensure that the shielding component is inserted into the socket in a correct orientation.

14. The connector of claim 13, wherein a first step portion is formed on the inner peripheral surface of the socket, a first locking spring of the shielding component is axially pressed against the first step portion to prevent the shielding component from being pulled out of the socket.

15. The connector of claim 13, wherein the socket has a front port and a rear port that are opposite in the axial direction, the shielding component is inserted into the socket through the front port, the connector further comprises a terminal holder which is cylindrical and is inserted into the cylindrical body of the shielding component through the rear port of the socket, a second step portion is formed on the terminal holder, a second locking spring of the shielding component is axially pressed against the second step portion to prevent the terminal holder from being pulled out of the shielding component.

16. The connector of claim 15, wherein a third step portion is formed on the terminal holder, a positioning protrusion of the shielding component is axially pressed against the third step portion to axially position the terminal holder.

17. The connector of claim 15, further comprising:
a terminal inserted into the terminal holder for mating with a mating terminal of a mating connector inserted into the socket; and
a cable having an end extending into the terminal holder through the rear port of the socket and electrically connected to the terminal.

18. The connector of claim 17, further comprising a shielding connection component that is cylindrical in shape, the shielding connection component has a front end fitted onto a rear end of the terminal holder, a rear end of the shielding connection component is pressed onto an exposed shielding layer of the cable, the front end of the shielding connection component is inserted into a rear end of the shielding component and electrically contacts a plurality of contact spring arms of the shielding component to achieve electrical connection between the shielding component and the exposed shielding layer of the cable.

19. The connector of claim 18, further comprising a supporting sleeve fitted onto the cable to support the rear end of the shielding connection component, the exposed shielding layer of the cable is folded back onto an outer side of the supporting sleeve and clamped between the rear end of the shielding connection component and the supporting sleeve.

20. The connector of claim 19, further comprising a sealing ring fitted onto the cable and inserted into the rear port of the socket to seal the rear port of the socket.

21. The connector of claim 20, further comprising a rear cover fitted onto the cable and fastened to a rear end of the housing, and a cable clamp fitted onto the cable and accommodated in the rear cover, the cable clamp has a plurality of elastic claws surrounding the cable, which clamp the cable under a radial compression of the rear cover to fix the cable to the housing.

22. The connector of claim 21, wherein the terminal holder, the terminal, the cable, the shielding connection component, the supporting sleeve, the sealing ring, the cable clamp, and the rear cover are pre-assembled into a cable assembly and inserted together into the socket of the housing.

23. The connector according to claim 22, wherein the socket is one of a plurality of sockets of the housing, the shielding component is one of a plurality of shielding components respectively inserted into the sockets of the housing from a front end of the housing, the cable assembly is one of a plurality of cable assemblies respectively inserted into the sockets from the rear end of the housing.
